(19) United States
(12) Patent Application Publication
(10) Pub. No.: US 2015/0044638 A1
(43) Pub. Date: Feb. 12, 2015

(54) DENTAL IMPLANT

(71) Applicant: Ebless Victor Baez, Gallup, NM (US)

(72) Inventor: Ebless Victor Baez, Gallup, NM (US)

(21) Appl. No.: 13/960,871

(22) Filed: Aug. 7, 2013

(51) Int. Cl. A61C 8/00; A61C 13/08

(52) U.S. Cl. CPC A61C 8/0025; A61C 8/0075; A61C 8/0059; A61C 13/08; A61C 8/0001
USPC 433/174

(57) ABSTRACT

A dental implant is provided configured to reduce micro-vibrational forces when in use, the implant having a first end with a plurality of threads, a first helical thread having an angle of about 5 degrees with respect to the transverse axis, and a set of threads having an angle of greater than about 50 degrees with respect to the transverse axis; each helical thread of the plurality of threads having a cross section that is arcuate in profile with non-planar flanks and a non-planar root. The implant also includes a second end configured as an abutment to accept a prosthetic device thereon, where the abutment has at least one annular groove positioned generally perpendicular to the longitudinal axis to mate with an internal projection on a prosthetic device.

### BACKGROUND

The embodiments herein relate generally to dental implants and more specifically to dental implants to minimize micro-vibrational forces that often result in the failure of prior art dental implants to maintain long term effectiveness.

### SUMMARY

A dental implant system is provided to reduce micro-vibrational forces when in use, thereby maximizing the useful life of the dental implant system. In one embodiment, the dental implant system has a longitudinal axis and a transverse axis, and comprises a first end comprising a plurality of threads, a first helical thread comprising an angle of about 5 degrees with respect to the transverse axis, and a plurality of threads comprising an angle of greater than about 50 degrees with respect to the transverse axis; each helical thread of the plurality of threads comprising a cross section that is arcuate in profile with non-planar flanks and a non-planar root; and a second end comprising an abutment configured to accept a prosthetic device thereon, the abutment comprising at least one annular groove positioned generally perpendicular to the longitudinal axis, the at least one groove configured in cross-section to accept an internal projection on a prosthetic device to permit the projection to snap-fit into the groove when the prosthetic device is placed on the abutment during use.

### BRIEF DESCRIPTION OF THE FIGURES

The detailed description of some embodiments of the invention will be made below with reference to the accompanying figures, wherein like numerals represent corresponding parts of the figures.

FIG. 1 shows a schematic perspective view of one embodiment of the present invention;

FIG. 2 shows a schematic top view of the embodiment of FIG. 1

FIG. 3 shows a schematic side view of the embodiment of FIG. 1.

### DETAILED DESCRIPTION OF CERTAIN EMBODIMENTS

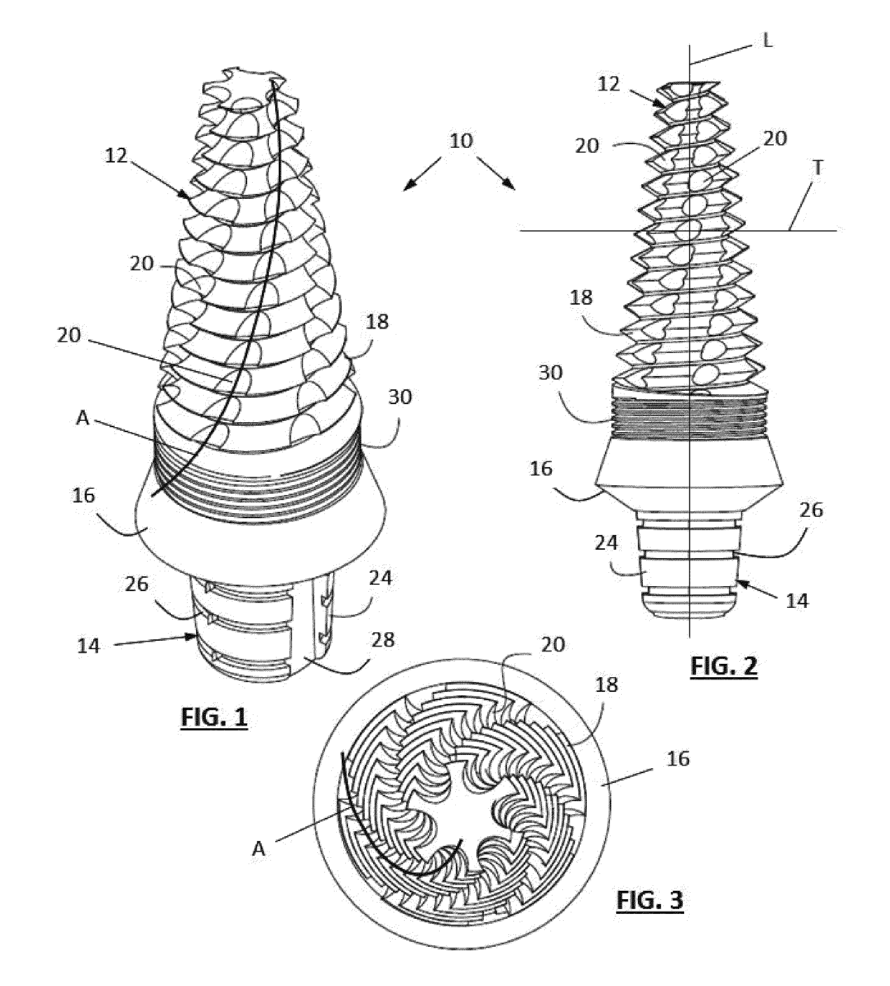

By way of example, and referring to FIGS. 1 through 3, one embodiment of the present system comprises a dental implant system 10 configured to reduce micro-vibrational forces when in use, thereby maximizing the useful life of the dental implant system. The dental implant system 10 has a longitudinal axis L and a transverse axis T (FIG. 2), where the implant system 10 comprises a first end 12 and a second end 14. In one embodiment, the system 10 has a collar 16 between the first and second ends, 12, 14, where the collar may comprise converging tapered surfaces or another of one of several configurations.

The first end 12 of system 10 comprises a plurality of threads with at least one running substantially counter to the others. A first thread 18 (a single continuous thread in the embodiment illustrated in FIGS. 1-3) is configured in a generally helical arrangement about the longitudinal axis L of the implant system 10, where the thread is positioned, for example, at an angle of about 5 degrees with respect to the transverse axis T, although the angle may be different from one embodiment to the next. Such first helical thread is often used in dental implants to help secure the implant to the patient's jaw bone. In some embodiments, a second thread (not shown) may be employed in a double helical configuration with the same angle as the first thread 18.

Embodiments of the invention differ from the prior art by at least the fact that they comprise a second set of threads 20 configured in a generally helical arrangement about the longitudinal axis L of the implant system 10, where the threads are positioned, for example, at an angle of about 50 degrees or more with respect to the transverse axis T, although the angle may be different from one embodiment to the next. The first helical thread may comprise a generally V-shaped thread with generally planar flanks. In another embodiment, the first helical thread may comprise a root having a generally planar profile positioned between flanks.

Unlike the first thread 18 that, in the example embodiment shown comprises a single continuous thread, the second set of threads 20 comprises a plurality of threads, with each thread in the set being radially spaced apart. One such thread 20 of the second set is shown following helical line A (FIGS. 1 and 3). In some embodiments, the second set of threads 20 comprise a cross-section that is arcuate in profile with non-planar flanks and a non-planar root, such as the example illustrated in FIG. 3. Other cross-sections are contemplated for the second set of threads 20, including, for example, a generally parabolic cross-section.

The second end 14 of embodiments of the system 10 comprising an abutment 24 configured to accept a prosthetic device thereon. In some embodiments, the abutment 24 of the second end 14 comprises at least one annular groove 26 positioned generally perpendicular to the longitudinal axis L, although a plurality of such grooves 26 may be employed, such as in the embodiment of FIGS. 1 through 3, with each one spaced from an adjacent one. The at least one groove 26 is preferably configured in cross-section to accept an internal projection on a prosthetic device, such as a coping or a tooth prosthetic, to permit the projection to snap-fit into the groove when the prosthetic device is placed on the abutment during use. A key 28 may also be employed to lock the prosthetic in radial position affixed to the abutment. Advantageously, the combination of the first thread with the second set of helical threads combine to present anti-vibrational stability when the dental implant is implanted within a person's jaw bone, thereby minimizing the risk of failure due to micro-vibrational forces that may be experienced by the dental implant during normal use.

In some embodiments, the first and second ends 12, 14 (i.e., the plurality of threads and the abutment) may comprise a unitary construction, or the abutment and the threads may comprise discrete components that can be secured together, where in one application the abutment may be configured to be secured to the first end after the first end has been implanted within a person's jaw bone.

It is contemplated that embodiments of the implant system comprise a kit that includes one or more embodiments as well as a prosthetic device (not shown) configured to mate with the abutment end of such embodiments. For example, such prosthetic devices may comprise the projections mentioned above to fit securely over the abutment when in use. In some cases, the kit may include a prosthetic device comprising a coping and/or a prosthetic tooth.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A dental implant system configured to reduce micro-vibrational forces when in use, thereby maximizing the useful life of the dental implant system, the dental implant system having a longitudinal axis and a transverse axis, the system comprising:
a first end comprising a plurality of threads, a first helical thread comprising an angle of about 5 degrees with respect to the transverse axis, and a plurality of threads comprising an angle of greater than about 50 degrees with respect to the transverse axis; each helical thread of the plurality of threads comprising a cross section that is arcuate in profile with non-planar flanks and a non-planar root; and
a second end comprising an abutment configured to accept a prosthetic device thereon, the abutment comprising at least one annular groove positioned generally perpendicular to the longitudinal axis, the at least one groove configured in cross-section to accept an internal projection on a prosthetic device to permit the projection to snap-fit into the groove when the prosthetic device is placed on the abutment during use;
wherein the combination of the first set and second set of helical threads combine to present anti-vibrational stability when the dental implant is implanted within a person's jaw bone, thereby minimizing the risk of failure due to micro-vibrational forces that may be experienced by the dental implant during normal use.

2. The dental implant system of claim 1, wherein the plurality of helical threads comprise a generally parabolic cross-section.

3. The dental implant system of claim 1, wherein the first helical thread comprises a generally V-shaped thread with generally planar flanks.

4. The dental implant system of claim 3, wherein the first helical thread comprises a root having a generally planar profile positioned between the flanks.

5. The dental implant system of claim 1, wherein the abutment and the threads are made as a unitary implant.

6. The dental implant system of claim 1, wherein the abutment of the second end and the threads of the first end comprise discrete components that may be secured together, the abutment being configured to be secured to the first end after the first end has been implanted within a person's jaw bone.

7. The dental implant system of claim 1, wherein the abutment further comprises a plurality of grooves positioned peripherally generally perpendicular to the longitudinal axis, each one spaced from an adjacent groove.

8. A dental implant kit comprising the implant of claim 1, and further comprising a prosthetic device configured to mate securely with the abutment of the implant without the need for adhesive.

9. The dental implant kit of claim 8, wherein the prosthetic device comprises a coping.

10. The dental implant kit of claim 8, wherein the prosthetic device comprises a tooth prosthesis.
